(19) United States
(12) Patent Application Publication
(10) Pub. No.: US 2025/0112489 A1
(43) Pub. Date: Apr. 3, 2025

(54) POWER SUPPLY SYSTEM

(71) Applicant: TOYOTA JIDOSHA KABUSHIKI KAISHA, Toyota-shi, (JP)

(72) Inventor: Yoshiyuki TAKAHARA, Toyota-shi (JP)

(73) Assignee: TOYOTA JIDOSHA KABUSHIKI KAISHA, Toyota-shi, (JP)

(21) Appl. No.: 18/766,910

(22) Filed: Jul. 9, 2024

(30) Foreign Application Priority Data
Oct. 3, 2023 (JP) 2023-172210

(51) Int. Cl. H02J 7/00; H02J 9/00

(52) U.S. Cl. CPC H02J 7/007188; H02J 7/0063; H02J 9/00

(57) ABSTRACT

A power supply system for controlling power supply to a load using a main equipment battery and an auxiliary equipment battery, the power supply system comprising: an acquisition unit that acquires charge/discharge information of the auxiliary equipment battery at a predetermined timing and accumulates the charge/discharge information as a charge/discharge history; a correction unit that corrects an internal resistance value of the auxiliary equipment battery based on the charge/discharge history; and a determination unit that determines whether backup power supply by the auxiliary equipment battery is possible when the main equipment battery fails based on the internal resistance value of the corrected auxiliary equipment battery.

### CROSS-REFERENCE TO RELATED APPLICATION

This application claims priority to Japanese Patent Application No. 2023-172210 filed on Oct. 3, 2023, incorporated herein by reference in its entirety.

### BACKGROUND

### 1. Technical Field

The present disclosure relates to a power supply system that controls power supply to a load using a main equipment battery and an auxiliary equipment battery.

### 2. Description of Related Art

Japanese Unexamined Patent Application Publication No. 2022-190470 (JP 2022-190470 A) discloses a power supply control device including a main power supply that supplies electric power to a load, and an auxiliary power supply that backs up power supply to the load when the main power supply fails. In this power supply control device, whether the auxiliary power supply can output electric power necessary for a backup process to the load when the main power supply fails is determined by causing a predetermined current to flow from the auxiliary power supply to the load.

### SUMMARY

It is conceivable to provide a backup function to an auxiliary equipment battery mainly intended to supply electric power to an auxiliary equipment load instead of providing the dedicated auxiliary power supply for the backup process for the main power supply. However, the auxiliary equipment battery is constantly influenced by polarization due to not only a charging process from a main equipment battery (main power supply) but also, for example, a normal power supply process for the auxiliary equipment load and a discharge process (pumping-out process) for the main equipment battery along with a power decrease in the main equipment battery. Thus, the auxiliary equipment battery is influenced more greatly by polarization than the dedicated auxiliary power supply. Therefore, when the backup possibility determination described in JP 2022-190470 A is made, there is a possibility that determination cannot appropriately be made as to whether the auxiliary equipment battery can output electric power necessary for backup.

The present disclosure has been made in view of the above problem, and an object of the present disclosure is to provide a power supply system capable of appropriately determining whether backup is possible in an auxiliary equipment battery that is influenced greatly by polarization.

In order to solve the above problem, an aspect of the technology of the present disclosure is a power supply system configured to control power supply to a load using a main equipment battery and an auxiliary equipment battery. The power supply system includes: an acquisition unit configured to acquire charge and discharge information of the auxiliary equipment battery at a predetermined timing and store the charge and discharge information as a charge and discharge history; a correction unit configured to correct an internal resistance value of the auxiliary equipment battery based on the charge and discharge history; and a determination unit configured to determine whether backup power supply by the auxiliary equipment battery is possible when the main equipment battery fails, based on the corrected internal resistance value of the auxiliary equipment battery.

With the power supply system of the present disclosure, it is possible to appropriately determine whether the auxiliary equipment battery can output electric power necessary for backup in consideration of the influence of polarization along with charging and discharging action.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a functional block diagram of a power supply system and a peripheral portion thereof according to an embodiment of the present disclosure;

FIG. 2 is a flowchart for explaining a procedure of charging and discharging history processing of an auxiliary equipment battery executed by a control device;

FIG. 3 is a diagram illustrating an example of a charge/discharge history of an auxiliary equipment battery; and

FIG. 4 is a flow chart which describes the procedure of the backup propriety decision processing of the auxiliary equipment battery which a control device performs.

### DETAILED DESCRIPTION OF EMBODIMENTS

The power supply system of the present disclosure acquires information on charge and discharge performed by the auxiliary equipment battery at any time, and accumulates the acquired information as a charge and discharge history (histogram or the like). Then, the power supply system corrects the discharge resistance value of the auxiliary equipment battery based on the influence of the polarization that the auxiliary equipment battery is subjected to, which is estimated from the charge and discharge history. Further, the power supply system appropriately determines whether backup power supply by the auxiliary equipment battery is possible when the main equipment battery fails based on the corrected discharge resistance value. Hereinafter, an embodiment of the present disclosure will be described in detail with reference to the drawings.

### EMBODIMENT

### Configuration

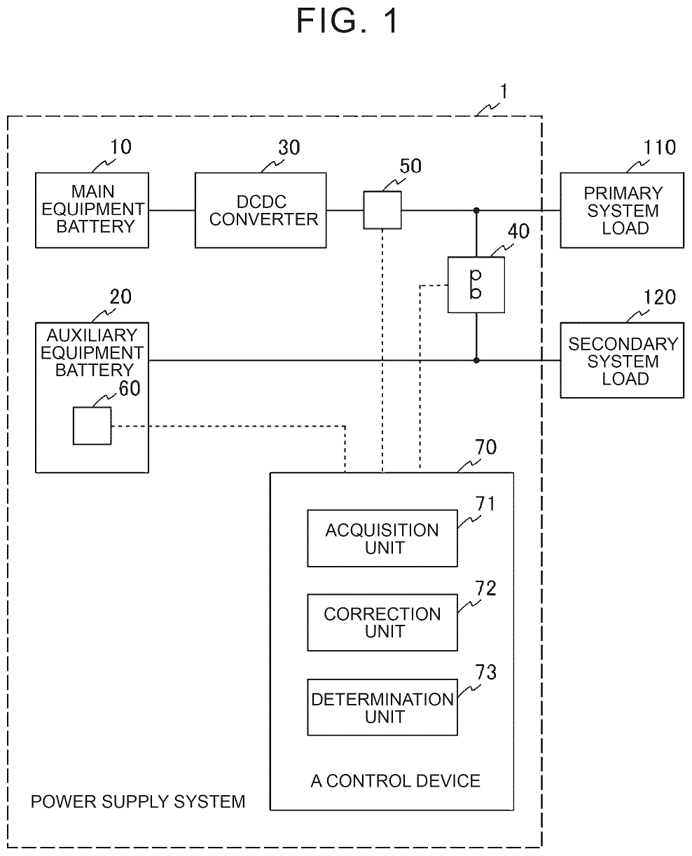

FIG. 1 is a functional block diagram of a power supply system 1 and a peripheral portion thereof according to an embodiment of the present disclosure. The functional blocks illustrated in FIG. 1 include a power supply system 1, a primary system load 110, and a secondary system load 120. The power supply system 1 includes a main equipment battery 10, an auxiliary equipment battery 20, a DCDC converter 30, a switch 40, a first sensor 50, a second sensor 60, and a control device 70. In FIG. 1, a power line through which power is transmitted and received is indicated by a solid line, and a signal line through which a control instruction or a measurement value flows is indicated by a broken line.

As an example, the configuration of the power supply system 1 illustrated in FIG. 1 can be mounted in a vehicle in which a function (load) that requires a redundant power supply configuration such as automatic driving is mounted. Vehicles equipped with functions (loads) requiring redundant power supply configurations such as autonomous driving are vehicles such as hybrid electric vehicle (HEV), plug-in hybrid electric vehicle (PHEV), and battery electric vehicle (BEV). Hereinafter, a case where the power supply system 1 according to the present embodiment is mounted on a vehicle will be described as an example.

The main equipment battery 10 is a secondary battery configured to be chargeable and dischargeable, such as a lithium-ion battery. The main equipment battery 10 supplies the electric power stored therein to the primary system load 110, the secondary system load 120, and the auxiliary equipment battery 20 via DCDC converter 30 and the switch 40. The main equipment battery 10 may store electric power output by a generator (not shown) such as an alternator. In the vehicle, for example, the driving battery corresponds to the main equipment battery 10.

The auxiliary equipment battery 20 is a secondary battery configured to be chargeable and dischargeable, such as a lead-acid battery or a lithium-ion battery. The auxiliary equipment battery 20 stores electric power outputted from the main equipment battery 10 via DCDC converter 30, and supplies the electric power stored therein to the secondary system load 120 and the auxiliary load (not shown). The auxiliary equipment battery 20 is provided with a function of performing a backup process in which, when an abnormality occurs in the main equipment battery 10 due to a power failure or the like, power supply to the secondary system load 120 is maintained (continued) instead of the main equipment battery 10. In the power supply system 1 of the present embodiment, a determination as to whether or not a suitable backup process is possible is realized in consideration of the influence of polarization occurring in the auxiliary equipment battery 20.

DCDC converter 30 is provided between the main equipment battery 10 and the auxiliary equipment battery 20, the primary system load 110, and the secondary system load 120. DCDC converter 30 is a voltage converter for converting the input voltage of the main equipment battery 10 into a voltage required for the auxiliary equipment battery 20, the primary system load 110, and the secondary system load 120, and outputting the converted voltage. DCDC converter 30 may be, for example, a step-down type DCDC converter in which the voltage of the main equipment battery 10 is stepped down and outputted to the auxiliary equipment battery 20, the primary system load 110, and the secondary system load 120.

The primary system load 110 is an in-vehicle device that operates with electric power supplied from the main equipment battery 10. The primary system load 110 includes important in-vehicle equipment related to the safe running of the vehicle. An example of an important in-vehicle device is a device or a system in which the evacuation action must be performed by a redundant power supply. The evacuation action is to cause the vehicle to travel until the vehicle is stopped at a safe place in an emergency such as a failure of the main power supply in the automatic operation. Devices and systems that require the evacuation action to be performed by a redundant power supply are brakes, steering, shift-by-wire, etc.

The secondary system load 120 is an in-vehicle device in which the main equipment battery 10 is used as a main power source and the auxiliary equipment battery 20 is used as a redundant power source. The secondary system load 120 operates with electric power supplied from the main equipment battery 10 or electric power supplied from the auxiliary equipment battery 20 via DCDC converter 30. The secondary system load 120 is redundantly provided with the same in-vehicle equipment as the important in-vehicle 15 equipment related to the safe running of the vehicle included in at least the primary system load 110.

The switch 40 is inserted between the primary system load 110 and the secondary system load 120, and is configured to electrically connect or disconnect the primary system load 110 and the secondary system load 120 under the control of the control 20 device 70.

The first sensor 50 is a configuration for detecting a voltage outputted from the main equipment battery 10 via DCDC converter 30, that is, a voltage of the primary system, and is typically a voltage sensor. Information on the primary system voltage detected by the first sensor 50 is output to the control device 70.

The second sensor 60 is configured to detect the state of the auxiliary equipment battery 20. The second sensor 60 includes a voltage sensor for detecting a voltage of the auxiliary equipment battery 20, a current sensor for detecting a current of the auxiliary equipment battery 20, a temperature sensor for detecting a temperature of the auxiliary equipment battery 20, and the like. Information regarding the state of the auxiliary equipment battery 20 detected by the second sensor 60 is output to the control device 70.

The control device 70 is a device for determining whether or not the auxiliary equipment battery 20 is in a state in which the main equipment battery 10 can be backed up in an emergency, and executing a backup process when it is possible. The control device 70 includes an acquisition unit 71, a correction unit 72, and a determination unit 73.

The acquisition unit 71 acquires information on the primary system voltage from the first sensor 50, and determines whether an abnormality of a power loss (such as a ground fault) has occurred in the primary system. This determination can be made based on whether or not the detection value of the first sensor 50 is lower than, for example, a lower limit voltage value appearing in the primary system in a normal state in which no abnormality has occurred. Further, the acquisition unit 71 acquires information on the state of the auxiliary equipment battery 20 from the second sensor 60, acquires the charge/discharge state related to the charge action and the discharge action performed in the auxiliary equipment battery 20, and accumulates it as a charge/discharge history. This charging and discharging history will be described later.

The correction unit 72 calculates the degree of influence indicating the influence of the charging and discharging process on the auxiliary equipment battery 20 based on the charging and discharging history of the auxiliary equipment battery 20 accumulated by the acquisition unit 71. Then, the correction unit 72 calculates a correction value based on the calculated degree of influence, and corrects the internal resistance value (discharge resistance value) of the auxiliary equipment battery 20 related to discharge using the correction value. For deriving the internal resistance value, various well-known methods such as determining a slope from a combination of the voltage value and the current value of the auxiliary equipment battery 20 can be used. The degree of influence and the correction value will be described later.

When the main equipment battery 10 fails, the determination unit 73 determines whether or not the auxiliary equipment battery 20 is in a state in which the predetermined backup power can be output to the secondary system load 120. This determination is made based on the internal resistance value (discharge resistance value) of the auxiliary equipment battery 20 after the correction by the correction unit 72.

Some or all of the control device 70 may be configured as an electronic control unit (ECU: Electronic Control Unit) that typically includes a processor, such as a microcomputer, memories, and input/output interfaces. The electronic control unit can realize some or all of the functions performed by the components of the acquisition unit 71, the correction unit 72, and the determination unit 73 by the processor reading and executing the program stored in the memory.

### Control

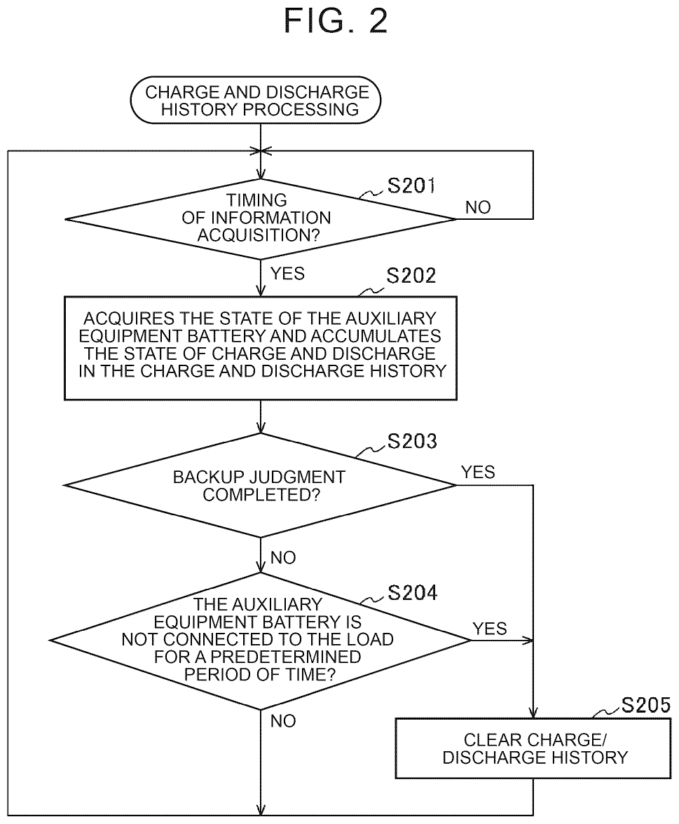

Next, the control performed by the power supply system 1 according to the present embodiment will be described with further reference to FIGS. 2, 3, and 4. In the present embodiment, the charge/discharge history processing and the backup availability determination processing are performed by the control device 70 of the power supply system 1.

### Charge and Discharge History Processing

FIG. 2 is a flowchart for describing the procedure of the charging and discharging history processing of the auxiliary equipment battery 20 executed by the control device 70. The charging and discharging history processing of the auxiliary equipment battery 20 illustrated in FIG. 2 is repeatedly performed at predetermined timings such as a fixed cycle (periodic processing including IG-OFF activation of vehicles).

### S201

The acquisition unit 71 determines whether or not it is a timing for acquiring information on the state of the auxiliary equipment battery 20 from the second sensor 60. For this timing, a certain period (for example, several hundred milliseconds) or the like can be arbitrarily set. When the acquisition unit 71 determines that the timing is the timing of the information acquisition (S201, Yes), the process proceeds to S202.

### S202

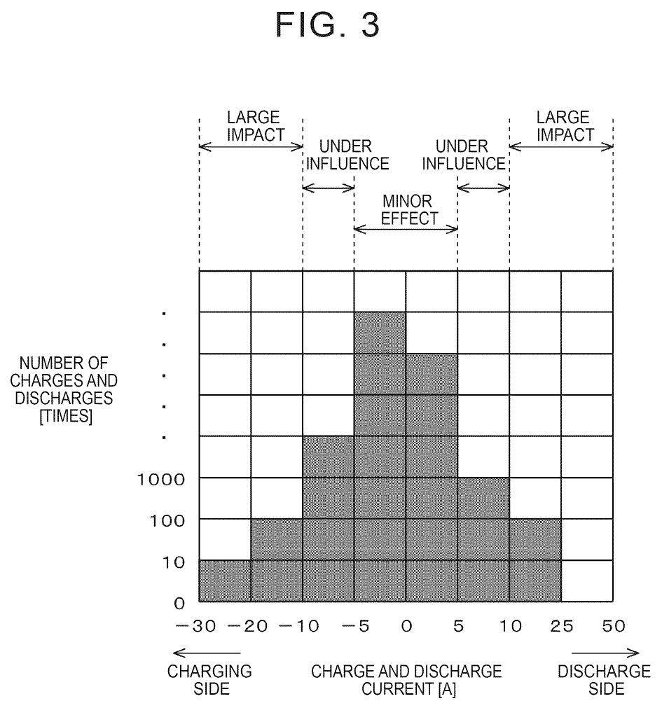

The acquisition unit 71 acquires information on the state of the auxiliary equipment battery 20 from the second sensor 60, and accumulates the charge/discharge action performed in the auxiliary equipment battery 20 as a charge/discharge history. FIG. 3 shows an example of the charge/discharge history of the auxiliary equipment battery 20.

The charging and discharging history illustrated in FIG. 3 is frequency information of charging and discharging by a histogram in which the number of times the charging and discharging action has occurred is divided for each current amount. Note that the discharge current flowing out of the auxiliary equipment battery 20 is referred to as a positive sign, and the charging current flowing into the auxiliary equipment battery 20 is referred to as a negative sign. For example, FIG. 3 shows that the number of times that a current of 5 amperes or more and less than 10 amperes is discharged from the auxiliary equipment battery 20 is 100 times or more and less than 1000 times. Further, FIG. 3 shows that the number of times the auxiliary equipment battery 20 is charged with a current of 10 amperes or more and less than 20 amperes is 10 times or more and less than 100 times. In this charge and discharge history, it is determined that the influence of polarization in the auxiliary equipment battery 20 is small if the current (absolute value) flowing by the charge and discharge action is small, and that the influence of polarization in the auxiliary equipment battery 20 is large if the current (absolute value) flowing by the charge and discharge action is large.

When the charging/discharging history of the auxiliary equipment battery 20 is accumulated by the acquisition unit 71, the process proceeds to S203.

### S203

The determination unit 73 determines whether or not the backup determination of the auxiliary equipment battery 20 has been performed. The backup availability determination uses the charge/discharge history of the auxiliary equipment battery 20 accumulated from the time of the previous backup availability determination to the time of the current backup availability determination. Therefore, this determination is made in order to determine whether or not the charge/discharge history accumulated so far is unnecessary.

When the determination unit 73 determines that the backup-availability determination of the auxiliary equipment battery 20 has already been performed (S203, Yes), the process proceeds to S205. On the other hand, when the determination unit 73 determines that the backup-availability determination of the auxiliary equipment battery 20 has not yet been performed (S203, No), the process proceeds to S204.

### S204

The determination unit 73 determines whether or not a state in which the auxiliary equipment battery 20 is not connected to the primary system load 110 and the secondary system load 120 continues for a predetermined time. Disconnected states include those in which the auxiliary equipment battery 20 is not capable of performing power functions and the terminals of the auxiliary equipment battery 20 are physically disconnected. If the auxiliary equipment battery 20 is not functioning, the charging and discharging history of the auxiliary equipment battery 20 is unnecessary, and thus this determination is performed.

When the determination unit 73 determines that the auxiliary equipment battery 20 is not connected to the primary system load 110 and the secondary system load 120 continuously for a predetermined period of time (S204, Yes), the process proceeds to S205. On the other hand, when the determination unit 73 determines that the auxiliary equipment battery 20 is not connected to the primary system load 110 and the secondary system load 120 continuously for a predetermined period of time (S204, No), the process proceeds to S201.

### S205

The determination unit 73 clears (erases) the accumulated charge/discharge history of the auxiliary equipment battery 20. As a result, the storage area for storing the charge/discharge history is opened, so that it is not necessary to prepare a large storage area for storing all the large charge/discharge histories in the past. When the determination unit 73 clears the charge/discharge history of the auxiliary equipment battery 20, the process proceeds to S201.

### Backup Availability Determination Processing

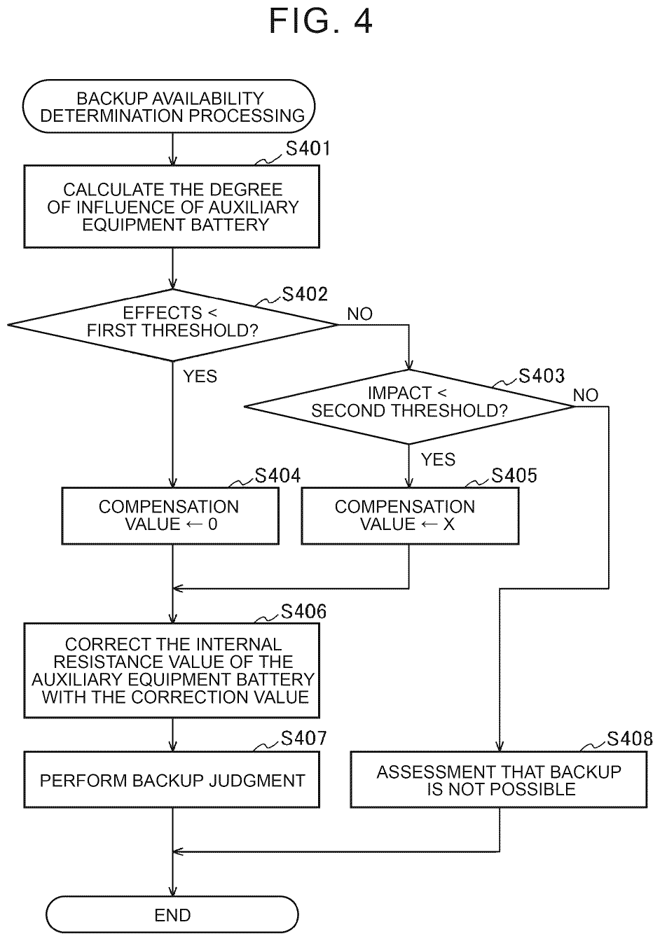

FIG. 4 is a flowchart for explaining the procedure of the backup availability determination process of the auxiliary equipment battery 20 executed by the control device 70. The backup availability determination process of the auxiliary equipment battery 20 illustrated in FIG. 4 is started, for example, when the vehicle is in the ignition-on state (IG-ON).

### S401

The correction unit 72 calculates the degree of influence of the auxiliary equipment battery 20 based on the charging and discharging history of the auxiliary equipment battery 20 accumulated by the acquisition unit 71 in the charging and discharging history processing. This degree of influence is a score quantitatively representing the influence of the polarization caused by the charging and discharging process on the auxiliary equipment battery 20. A method of calculating a score will be exemplified by using the charge/discharge history illustrated in FIG. 3 as an example. As a method of calculating the score, it is possible to exemplify that an intermediate value of each section of the charge/discharge current is used as a score, and the score of the section is increased in proportion to the number of charge/discharge operations of the section, and the total score of the entire charge/discharge history is calculated as an influence degree. Note that this score calculation method is merely an example, and it is possible to calculate a score using various other methods. When the degree of influence of the auxiliary equipment battery 20 is calculated by the correction unit 72, the process proceeds to S402.

### S402

The correction unit 72 determines whether or not the degree of influence of the auxiliary equipment battery 20 is less than the first threshold value. This determination is made to determine whether the auxiliary equipment battery 20 is affected by polarization. Therefore, the first threshold value is set to a value equal to or less than the minimum influence degree (score) calculated from the charge/discharge history in which the charge/discharge operation is performed, which is estimated to have an influence of polarization on the auxiliary equipment battery 20.

If the correction unit 72 determines that the degree of influence of the auxiliary equipment battery 20 is less than the first threshold (S402, Yes), the process proceeds to S404. On the other hand, when the correction unit 72 determines that the degree of influence of the auxiliary equipment battery 20 is equal to or greater than the first threshold (S402, No), the process proceeds to S403.

### S403

The correction unit 72 determines whether or not the degree of influence of the auxiliary equipment battery 20 is less than the second threshold. This determination is made in order to determine whether or not the influence of the polarization occurring in the auxiliary equipment battery 20 is so large as not to be able to determine whether or not backup is possible. Therefore, the second threshold value is set to a value equal to or greater than the maximum degree of influence (score) calculated from the charge-discharge history in which the charge-discharge action is performed, which is estimated to be able to cope with the influence of the polarization extending to the auxiliary equipment battery 20 (to be able to determine whether or not backup is possible). The second threshold value is set to be larger than the first threshold value.

If the correction unit 72 determines that the degree of influence of the auxiliary equipment battery 20 is less than the second threshold (S403, Yes), the process proceeds to S405. On the other hand, when the correction unit 72 determines that the degree of influence of the auxiliary equipment battery 20 is equal to or greater than the second threshold (S403, No), the process proceeds to S408.

### S404

The correction unit 72 sets the correction value to “0 (zero)”. This correction value is a value (resistance value) for correcting the internal resistance value of the auxiliary equipment battery 20 obtained from the actual value detected by the second sensor 60. When the correction unit 72 sets the correction value to “0”, the process proceeds to S406.

### S405

The correction unit 72 sets the correction value to “X (integer or rational number)”. The correction value=X can be derived using, for example, a map in which the degree of influence and the correction value are associated with each other. In the auxiliary equipment battery 20, charge polarization is generated by the charging process, and discharge polarization is generated by the discharging process. For this reason, it is necessary to estimate the internal resistance value (discharge resistance value) to be smaller than the actual measurement value in accordance with the degree of influence (negative sign) indicating that the discharge action is more frequent than the charge action. In addition, for the degree of influence (positive sign) indicating that there are more charging acts than the discharging acts, it is necessary to estimate the internal resistance value (discharge resistance value) to be larger than the actual measurement value in accordance with the degree. Therefore, it is desirable that the correspondence map between the degree of influence and the correction value is set in advance so that the internal resistance value can be corrected to a value in which the influence of the polarization of the auxiliary equipment battery 20 is taken into consideration. When the correction unit 72 sets the correction value to “X”, the process proceeds to S406.

### S406

The correction unit 72 corrects the internal-resistance value of the auxiliary equipment battery 20 using the correction value (0 or X) set by S404 or S405. The correction is performed by adding (or subtracting) the correction value to the internal resistance value that can be derived from the state of the auxiliary equipment battery 20 actually measured by the second sensor 60. By this correction, the influence of the polarization due to the charging and discharging action is reflected in the internal resistance value of the auxiliary equipment battery 20. When the internal-resistance value of the auxiliary equipment battery 20 is corrected by the correction unit 72 using the correction value, the process proceeds to S407.

### S407

Determination unit 73, based on the internal resistance value (discharge resistance value) of the auxiliary equipment battery 20 after correction, the auxiliary equipment battery 20 performs a “backup availability determination” to determine whether or not it is in a state in which it is possible to output a predetermined backup power to the secondary system load 120. A well-known method can be used for the backup propriety determination. When the backup availability determination is performed by the determination unit 73, the backup availability determination process of the auxiliary equipment battery 20 ends.

### S408

The determination unit 73 determines that the auxiliary equipment battery 20 is not in a state in which the predetermined backup power can be output to the secondary system load 120 (backup is not possible). When the determination unit 73 determines that backup is impossible, the backup availability determination process of the auxiliary equipment battery 20 ends.

### Operations and Effects

According to the power supply system 1 of the embodiment of the present disclosure described above, charge/discharge information of the auxiliary equipment battery 20 acquired at a predetermined timing is accumulated as a charge/discharge history, and the internal resistance value of the auxiliary equipment battery 20 is corrected based on the charge/discharge history. In this correction process, the degree of influence of the polarization generated in the charge-discharge process on the auxiliary equipment battery 20 is calculated based on the charge-discharge history, and the internal resistance value of the auxiliary equipment battery 20 is corrected using the correction value calculated based on the degree of influence. By this processing, it is possible to appropriately determine whether or not the auxiliary equipment battery 20 is capable of outputting power necessary for backup, taking into consideration the influence of the polarization of the auxiliary equipment battery 20 due to the charging and discharging action.

Further, according to the power supply system 1 of the present embodiment, the charge and discharge history of the auxiliary equipment battery 20 is stored in a histogram format. Accordingly, it is not necessary to store the detailed data detected by the second sensor 60 as it is, and the storage area for storing the charge/discharge history can be saved. Further, in the power supply system 1 according to the present embodiment, since the storage area is opened by clearing the unnecessary charge/discharge history, it is not necessary to prepare a large storage area.

Although an embodiment of the present disclosure has been described above, the present disclosure is not limited to the above-described power supply system. The present disclosure can be regarded as a method executed by a power supply system (control device) including a processor and a memory, a program of the method, or a computer-readable non-transitory recording medium storing the program. Further, the present disclosure can be regarded as a vehicle equipped with a power supply system or the like.

The power supply system of the present disclosure can be used for a vehicle including a main equipment battery and an auxiliary equipment battery.

What is claimed is:

1. A power supply system configured to control power supply to a load using a main equipment battery and an auxiliary equipment battery, the power supply system comprising:
an acquisition unit configured to acquire charge and discharge information of the auxiliary equipment battery at a predetermined timing and store the charge and discharge information as a charge and discharge history;
a correction unit configured to correct an internal resistance value of the auxiliary equipment battery based on the charge and discharge history; and
a determination unit configured to determine whether backup power supply by the auxiliary equipment battery is possible when the main equipment battery fails, based on the corrected internal resistance value of the auxiliary equipment battery.

2. The power supply system according to claim 1, wherein the charge and discharge history is frequency information of charging and discharging that is obtained by dividing the number of times of charging and discharging performed by the auxiliary equipment battery for each current amount.

3. The power supply system according to claim 2, wherein the correction unit is configured to calculate an influence degree indicating an influence of a charge and discharge process on the auxiliary equipment battery based on the frequency information, calculate a correction value based on the influence degree, and correct the internal resistance value of the auxiliary equipment battery using the correction value.

4. The power supply system according to claim 1, wherein the acquisition unit is configured to delete the charge and discharge history when the auxiliary equipment battery remains disconnected from the load continuously for a predetermined period.

5. The power supply system according to claim 3, wherein the determination unit is configured to determine that the backup power supply by the auxiliary equipment battery is impossible when the influence degree estimated by the correction unit is equal to or higher than a predetermined value.
